(19) United States
(12) Patent Application Publication
(10) Pub. No.: US 2007/0005169 A1
(43) Pub. Date: Jan. 4, 2007

(54) Device and method for automatically carrying out laboratory procedure steps

(76) Inventors: Peter Röhnert, Magdeburg (DE); Frank Striggow, Gerwisch (DE)

Correspondence Address: SMITH PATENT CONSULTING CONSULTING, LLC, P.O. BOX 2726, ALEXANDRIA, VA, 22301, US

(21) Appl. No.: 10/573,448

(22) PCT Filed: Sep. 24, 2004
(86) PCT No.: PCT/EP04/10755

§ 371 Date: Mar. 24, 2006

(30) Foreign Application Priority Data
Sep. 24, 2003 (DE) 103 44 284.7

(51) Int. Cl. G06F 19/00

(52) U.S. Cl. 700/100

(57) ABSTRACT

The present invention relates to a device for automatically carrying out laboratory operations on cell or tissue samples, which comprises a plurality of modular stations, each of which carries out at least one operation in a total sequence of operations, and at least one support unit for transporting sample containers to and between the stations, the device having at least one station for automatically changing liquid media in the sample containers.

The present invention relates to a device for automatically-carrying out laboratory operations on cell or tissue samples, which comprises a plurality of modular stations, each of which carries out at least one operation in a total sequence of operations, and at least one transport unit for transporting sample containers to and between the stations.

The development of new drug substances is extremely time-consuming and expensive. Within the conventional development process for active substances, particularly the identification and validation of therapeutic targets, the discovery of potential active substances and the preclinical phase comprise steps which have to be optimized in order to reduce time, costs and the risk of product failures in later development phases. The bottle necks in the preclinical phase have recently become more critical owing to progress in so-called “high-throughput screening” (HTS), combinatorial chemistry, computer-assisted biochemistry and virtual pharmacology, which deliver a large number of possible candidates for a new active substance.

Since the large number of possible candidate active substances can virtually no longer be further evaluated or can be further evaluated only with unacceptable effort in animal experiments, the pre-selection of promising candidate active substances by in vitro investigations on cells and cell tissue samples is becoming increasingly important. In vitro pre-evaluation helps to discard unsuitable candidate active substances even before the in vivo screening or to recognise particularly suitable targets and candidate active substances more rapidly.

Even if appropriate in vitro methods for screening active substances are relatively fast and economical in comparison with in vivo methods, there remains the problem that the cell tissue samples have to be cultivated in a complicated procedure and over a relatively long period, so that there is a need for automation of the laboratory operations owing to the large number of samples to be simultaneously processed, each of which has to be subjected to a long sequence of complex, chemical or analytical processing steps.

WO 02/49761 proposes an automated laboratory system, in particular for carrying out the PCR method. The device comprises a plurality of modular stations, each of which carries out at least one operation in a total sequence of operations, and a modular station which transports material to another station without human assistance.

DE 198 53 184 A1 discloses a device for transporting a support element having a plurality of sample wells, in particular a titer plate, to and between storage and/or processing stations, comprising a transport unit connecting a delivery and/or storage unit to at least one processing station, in particular a linearly operating transport unit, for transporting the support element, the processing station being set up in a modular manner and being capable of being equipped with at least one functional unit formed for carrying out an automatable processing function on the support element or the sample wells thereof, and the processing station having a pivot device which has at least one turntable or rotating arm for transferring a support element between transport unit and functional unit and is formed so that, as a reaction to an electronic control signal, a support element held by the pivot device pivots through a predetermined angle about an axis of rotation and can be transferred from the pivot device to an adjacent unit by displacement. This document proposes, as functional units, an incubator, a dispenser, a pipettor and a read unit for preferably optically readable identification provided on the support element.

The known laboratory automation devices are not very suitable for handling cell or tissue samples since the cultivation and processing of cell and tissue samples requires particular conditions over a relatively long period. An object of the present invention is therefore to provide a device for automatically carrying out laboratory operations on cell or tissue samples, by means of which these samples can also be cultivated over a relatively long period.

This object is achieved by a device for automatically carrying out laboratory operations on cell or tissue samples, which comprises a plurality of modular stations, each of which carries out at least one operation in a total sequence of operations, and at least one transport unit for transporting samples to and between the stations and wherein the said device has at least one station for automatically changing liquid media in the sample containers (media change station).

The laboratory operations may be part of complex and highly complex experimental sequences.

The device according to the invention comprises a plurality of modular stations which may be known automatic pipetting, metering or analysis units, as described, for example, in WO 02/49761 or DE 198 53 184. A suitable transport unit for transporting sample containers to and between the stations is, for example, the transport unit disclosed in DE 198 53 184.

The device according to the invention preferably comprises a sample input station, at least one incubator station, a media change station, a data acquisition station and a sample output station.

In the sample input station, the cell or tissue samples, for example juvenile cell tissue samples, in particular juvenile brain tissue samples (for example as hippocampus tissue sections) but also heart or liver tissue samples, such as cardiac atrium samples, are introduced into the device according to the invention. Sample containers in the form of plates having one or more wells which may contain membrane inserts are suitable for this purpose, it being possible for the plates to have a cover plate in each case. Appropriate sample containers are commercially available, for example, as so-called 6-well plates (also multiwell plates) and are used as tissue culture plates. These plates consist of a base plate and a removable cover. The base plate contains six wells. A membrane insert can be placed in each well. These are plates whose bottom is in the form of a membrane, e.g. in the form of a glass frit. At the sample input station, the membrane inserts are provided with tissue samples, in particular manually. For example, the tissue samples may be hippocampus sections of juvenile rat or heart or liver sections. Both animal and human tissue samples can be used.

Usually, at the request of the operator, the device according to the invention, at the sample input station, provides a sample container whose wells are already filled with a desired medium in a suitable amount. The sample container preferably contains water, in particular bidistilled water, between the wells in order to establish a desired relative humidity in the container. At the sample input station, the tissue sections are then introduced into the membrane inserts, and the sample container is then automatically transferred to the transport unit of the device.

Beforehand, the device according to the invention has, for example, already taken an empty sample container from a storage container and, in the media change station, filled its wells with the desired medium in a suitable amount and, if desired, the space between the wells with water. Before being provided to the sample input station, the multiwell plate can then be equilibrated in an incubator station, in particular an oxygen incubator station. This is effected automatically for a predetermined period. Alternatively, the device can take over the empty sample container at the sample input station instead of from a storage container.

The sample container which is preferably in the form of a multiwell plate is then transported by the transport unit, for example to an incubation station, and is stored in this under controlled conditions (for example temperature and gas composition). In a possible embodiment, the device according to the invention comprises at least two different incubator stations, an oxygen incubator station and a nitrogen incubator station. The climatic conditions in the oxygen incubator may be, for example, 95% of air and 5% of CO₂ at 36° C., and the climatic conditions in the nitrogen incubator may be 95% of N₂ and 5% CO₂ at 36° C.

For the successful cultivation of cell and tissue samples, the media used for storing the samples, in particular culture media, must be regularly changed. For this purpose, the sample containers are transported by the transport unit to the media change station. The media change station may comprise a unit for removing a liquid medium from the wells of the plate of a sample container and a unit for adding one or more liquid media to the wells of the plate of the sample container. Since the sample containers can be provided with a cover plate, the media change station can moreover comprise a unit for removing and mounting such a cover plate.

Particularly with the use of multiwell plates having membrane inserts as sample containers there is moreoever the problem that the liquid medium is present below the membrane insert in the wells of the multiwell plate. In order to facilitate the removal of the liquid medium from the wells of the multiwell plate, the media change station can therefore additionally be equipped with a unit for removing and inserting the membrane inserts from the wells of the plate of a sample container.

Particularly if a plurality of different liquid media are added to a well of the plate of the sample container it has moreover proven advantageous if the media change station has a unit for mixing liquid media in wells of a plate of a sample container.

The media change station therefore preferably operates as follows:

A sample container, preferably a multiwell plate, is transferred by the transport unit of the device according to the invention to the media change station. The media change station automatically recognises whether the transferred sample container has a cover plate. If the sample container has a cover plate, this is removed by the unit for removing the cover plate. This can be effected, for example, by a robot gripper which is equipped with tongs for gripping the cover plate or, for example, with a suction device for sucking up the cover plate by means of a vacuum.

The membrane inserts, if present, are then automatically removed from the wells of the plate of the sample container. This can be effected, for example, by robot grippers which can grip one or more of the membrane inserts simultaneously or in succession and remove them from the wells. For example, the robot gripper may have a member which penetrates the membrane inserts and spreads apart gripping elements there. The unit for removing the membrane inserts preferably has the same number of grippers as the sample containers used have membrane inserts, so that the unit can simultaneously grip and remove all membrane inserts of a sample container.

The unit for removing and inserting the membrane inserts could advantageously be capable of selectively removing only individual membrane inserts of the plurality of membrane inserts from the sample container, so that during the experiment, for example, samples recognised as being unusable can be removed. This also makes it possible to pool samples, for example of different origin, in one sample container during an ongoing experiment.

Since the membrane inserts may contain extremely sensitive tissue samples, it has moreover proven advantageous if the media change station furthermore has a unit for temporary storage of membrane inserts under controlled conditions. This may be, for example, a multiwell plate which contains suitable culture medium at a desired temperature in the wells. The unit for removing the membrane inserts can then place the membrane inserts which are removed from the sample container which was transferred to the media change station in the wells of the multiwell plate so that the tissue samples have to remain separated from a culture medium for only a short time.

In order to avoid entrainment of media from a sample container into the unit for temporary storage of membrane inserts or from this unit into another sample container, the device according to the invention may furthermore comprise a unit for removing liquid medium from membrane inserts. This may be, for example, a filter paper, a material web or a sponge on which the membrane inserts are placed and dried prior to insertion in or after removal from the unit for temporary storage of the membrane inserts.

After the removal of the membrane inserts from the plate of a sample container, said sample container is transported in the media change station to a unit for removing the liquid medium from the wells of the plate of the sample container. This can be effected, for example, by an automatic robot gripper or conveyer belt. Alternatively, in the case of a stationary sample container, the unit for removing the membrane inserts can be exchanged for the unit for removing the liquid medium. The removal of the liquid medium from the wells of the plate can be effected, for example, by automatically pouring the liquid medium from the wells or by sucking up the liquid medium. It has proven advantageous if the plate is tilted, for example, by about 45° for removing the liquid medium and the medium is then sucked up. As a result, the medium can be removed substantially completely from the wells.

The suction can be effected, for example, by means of one or more tubes which are automatically lowered from above into the wells and suck up the medium by means of a pump. The unit for removing the liquid medium preferably has the same number of tubes as the sample container used has wells, so that the medium can be sucked up simultaneously from all wells of the sample container used. Furthermore, it may be desirable for the unit for removing the liquid medium to have a plurality of different suction tubes for each well of the sample container, which suction tubes can be used alternatively for sucking up, so that different media can be collected separately from one another, for example in different collecting containers. Alternatively, the medium change station may have a plurality of units for removing the liquid medium, which are automatically selected as a function of the liquid medium which is to be removed from the sample container, in order to collect different liquid media separately from one another in different collecting containers.

After the removal of the liquid medium from the wells of the sample container, the latter is further transported to a unit for adding one or more liquid media to the wells of the sample container. This can be effected either by automatically further transporting the sample container, for example by a robot gripper or by means of a conveyor belt. Alternatively, in the case of a stationary sample container, the unit for removing the liquid media can be exchanged for the unit for adding one or more liquid media.

The unit for adding one or more liquid media may be, for example, a pipetting unit, by means of which a predetermined amount of one or more liquid media from one of more storage containers is introduced into a well of the sample container. The unit may have one or more appropriate pipetting devices in order to be able to introduce a plurality of different liquid media into the wells without a pipetting unit coming into contact with different media. The addition can be effected simultaneously or in succession. The unit can moreover have the same number of pipetting units or combinations of pipetting units as the sample containers used have wells, in order to be able to fill all wells of a sample container simultaneously. Alternatively, the unit may have fewer pipetting units or combinations of pipetting units than the sample container has wells. In this case, the wells of a sample container are filled in succession.

Particularly if a plurality of different liquid media have been introduced into a well of a sample container, it has proven advantageous if the media change station of the device according to the invention additionally has a unit for mixing the liquid media in the wells of the sample container. This may comprise, for example, stirrers which enter the wells from above and mix the introduced liquid media by stirring. It may alternatively be a vibrating table on which the sample containers are automatically placed. The different liquid media in the wells of the sample container are then mixed by vibration of the container.

After addition of the liquid medium or of the liquid media to the wells of the sample container, the membrane inserts are inserted again into the wells of the sample container by the unit for inserting the membrane inserts. Optionally, the membrane inserts are removed for this purpose from the unit for temporary storage and, if desired, cleaned by the unit for removing liquid medium from the membrane inserts. During insertion of the membrane inserts into the wells of the sample container it is important for the device according to the invention to insert the membrane inserts so that no air bubbles form between the surface of the liquid medium introduced and the bottom of the membrane insert, since said air bubbles could hinder the exchange of substances between the medium and, for example, the tissue sections on the surface of the membrane.

After the insertion of the membrane inserts into the wells of the sample container, the cover plate is optionally mounted again and the multiwell plate is transferred back from the media change station to the transport unit, which automatically further transports the sample container to the next modular station, for example an incubator station.

In the course of the total sequence of operations, the cell or tissue samples may be exposed, for example, to disease-simulating conditions in order subsequently to investigate the effects of these conditions on the samples and/or the influence of test substances on the samples under these conditions. For this purpose, for example in the media change station, a culture medium can be exchanged for another medium which does not contain the nutrients required by the tissue in order thus to simulate a deficiency of nutrients. Furthermore, the samples can, for example be incubated in a nitrogen incubator instead of an oxygen incubator in order to simulate a deficiency of oxygen.

At the same time or alternatively, one or more test substances whose action on the cell tissue samples is to be tested can be added to the liquid media in the wells of the sample container in a station for adding reagents to the sample containers. The station for adding reagents is preferably coupled to the media change station in order to avoid unnecessary operations. Simultaneously with or independently of the media change, the desired substance can then be introduced in a suitable amount into the wells of the sample container, for example by means of an automatic pipette.

The added substances may be, for example, specific substances for inducing or simulating different disease-relevant results (for example lipopolysaccharides (LPS) and/or specific cytokines for inducing inflammatory results). In addition, molecular biology tools (for example small interference RNA (siRNA) or antisense sequences) or molecular biology constructs (for example viral vectors) for manipulating the tissue-specific gene expression may be added with the aim of either inducing disease-relevant situations (e.g. Alzheimer-like pathophysiology) or of identifying or validating drug-relevant targets.

Alternatively or in addition to the test substance whose action on the cell tissue samples is to be tested, a substance which supports the recording of measured data of the cell tissue sample can optionally also be added to the wells of the sample container by the station for adding reagents. Such a substance may be, for example, propidium-iodide (PI), which is suitable for staining nucleic acids. Appropriately stained samples can then be investigated by means of fluorescence microscopy in the data acquisition station. For example, specific apoptosis markers, proliferation markers, cellular differentiation markers and fluorescence marked antibodies for visualising distinct proteins are suitable as further substances for supporting the recording of measured data (markers/readouts).

In order to be able to determine the influence of the incubation conditions (for example composition of the liquid or gaseous medium) and/or of test substances on the tissue samples, the device according to the invention preferably also comprises a data acquisition station in which relevant data of the samples can be acquired at the beginning of, during or at the end of the total sequence of operations, for example with the aid of a microscopy unit (for example a confocal, non-confocal or infrared microscopy unit). For example transmission images and/or, after staining with PI, fluorescence images of appropriate tissue samples can be recorded under the microscope. A comparison of the different recordings before, during and after appropriate treatment steps then enables the operator to determine whether and, if appropriate, to what extent the employed test substances and/or modifications of the incubation conditions have effect on the tissue cultures.

The preparation of transmission micrographs by the microscopy unit can be carried out fully automatically. For this purpose, a micrograph of the complete membrane insert is first prepared and the position of the individual tissue sections in a membrane insert is automatically recognised by suitable software. The individual tissue sections are then individually magnified for recording the transmission images. A corresponding procedure can be adopted for recording fluorescence images.

For example, devices for flow-through cytometry (FACS analysis), laser-based microdissection, mass spectrometry (e.g. MALDI/TOF analysis), spectroscopy (e.g. IR spectroscopy, fluorescence correlation spectroscopy) and electrophysiology (e.g. multi-electrode arrays) are also suitable as an additional or alternative data acquisition station. Suitable data acquisition stations can be chosen by the person skilled in the art as a function of the experiment carried out and the markers used.

After completion of the experiment, the sample containers are transported by the transport unit, preferably to a sample output station, and, for example, are collected there in order to enable them to be subsequently either disposed of or recycled. The device according to the invention may also have a plurality of sample output stations, for example two sample output stations, for sample containers, for example with different liquid media, if these media are to be collected and disposed of separately from one another.

In a possible embodiment, the device according to the invention comprises a combination of the following stations: a sample input station in which cell tissue samples are introduced manually into membrane plates which are present in the wells of a multiwell plate, the wells containing a culture medium for the cell tissue samples, an oxygen incubator station in which the cell tissue samples are cultivated, a media change station in which the culture media in the multiwell plates are changed after predetermined time intervals, a reagent addition station in which one or more test substances whose effects on the cell tissue samples are to be tested and/or optionally one or more substances which support the recording of measured data of the cell tissue samples are added to the wells of the multiwell plates, optionally a nitrogen incubator station in which the cell tissue samples are, if required, additionally incubated in the course of the experiment, a data acquisition station in which measured data of the cell tissue samples are acquired, for example before or after addition of a test substance and/or cultivation in the nitrogen incubator, in order to determine the influence thereof on the cell tissue samples, a sample output station in which multiwell plates are output from the device after completion of the investigations, and a transport unit for transporting the multiwell plates from the sample input station to and between the stations up to the sample output station.

The device according to the invention has the advantage that it permits, for example, tissue sections to be cultivated and the influences of test substances and disease simulating conditions on these tissue sections to be investigated fully automatically. The device according to the invention thus permits functional tissue-based screening, in particular with regard to disease-relevant effects. A bottle neck between the very fast HTS methods, which deliver a multiplicity of possible candidate active substances, and the comparatively slow and in particular expensive in vivo investigation is overcome thereby. The present invention thus also relates to the use of the device according to the invention for carrying out investigations of chemical, biological and/or physical influences on physiological or pathophysiological processes on samples such as cell tissue samples. In particular, the device can be used for testing the effect of substances on samples, preferably on cell tissue samples. Corresponding uses are described, for example, on the basis of vital mammalian heart tissue cells kept ex vivo in DE 103 22 986.8 of KeyNeurotek AG.

In addition, a method for testing the effect of substances on samples, preferably on cell tissue samples, is provided, which method comprises the input of samples into a device according to the invention and to the evaluation of measured data acquired in the data acquisition station. This method has the particular advantage that only the samples have to be manually prepared and the measured data manually evaluated. The labor-intensive, time-consuming and expensive intermediate steps of even the most complex experimental sequences are carried out fully automatically by the device according to the invention. It is therefore possible to investigate a large number of different samples and test substances simultaneously.

A further advantage of the device according to the invention consists in its modular design, which, depending on the sequence of the desired experiment, makes it possible to exchange individual modular stations for others or to provide the device with additional incubators or, for example, also with an additional media change station, for example for increasing the capacity. In principle, the device according to the invention is not subject to any capacity limits since its capacity can be increased at any time by adding further modular stations.

The present invention will now be explained in more detail with reference to a specific embodiment, but without limiting it thereto.

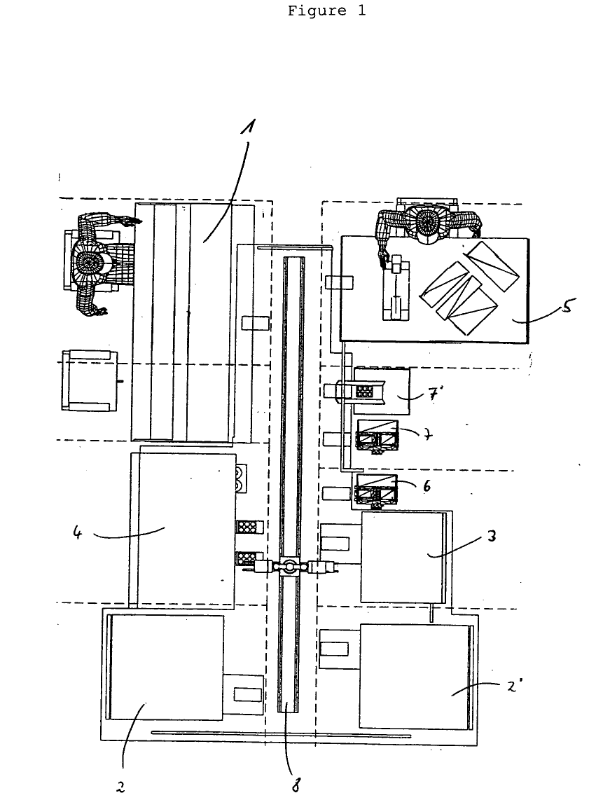

The attached FIG. 1 schematically shows a possible embodiment of the device according to the invention in plan view.

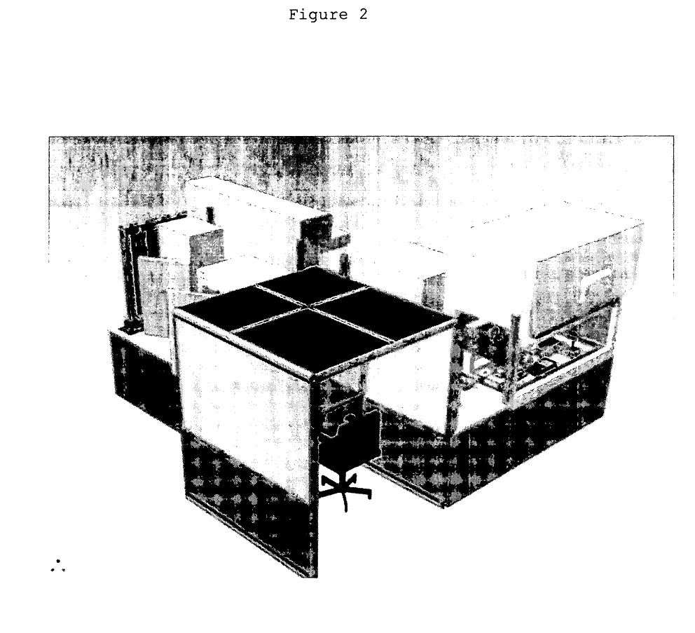

FIG. 2 shows the perspective diagram of another possible embodiment of the device according to the invention.

FIGS. 1 and 2 show a sample input station 1, two oxygen incubation stations 2 and 2′, a nitrogen incubation station 3, a media change station 4, a data acquisition station 5, a sample container storage station 6 and (only in FIG. 1), two sample output stations 7 and 7′ and a transport unit 8 for transporting the sample containers to and between the stations.

Below, the use of the device according to the invention for screening possible active substances against cerebral ischemia is described by way of example. Normal brain functions depend substantially on the permanent supply of glucose and oxygen. An interruption of the cerebrospinal blood flow by a stroke, brief stoppage of the heart or as a side effect of cardiac surgery rapidly leads to ischemic conditions in the brain and subsequently to the death of neuronal cells. For determining the effect of test substances on cerebral ischemia, hippocampus sections can first be cultivated according to known protocols and then exposed to ischemic conditions by withdrawal of oxygen and glucose. Damage to neuronal cells by these conditions can then be visualized, for example, by the intracellular fluorescence of added propidium iodide (PI), which is incorporated only into damaged cells. A possible positive effect of substances to be tested on the ability of neuronal cells to survive ischemic conditions is determined in a comparative experiment under the same conditions with simultaneous addition of the test substance to the culture medium.

The laboratory operations required for this purpose can, for example, be carried out as follows by the device according to the invention. First, empty multiwell plates with membrane inserts inserted into the wells are input into the device via the sample input station 1. The transport unit 8 transports the multiwell plates to the media change station 4, in which bidistilled water is introduced between the wells and glucose medium is introduced into all wells of the multiwell plates. The multiwell plates are then transported by the transport unit 8 into an oxygen incubator 2 or 2′, where they remain for between 20 minutes and 24 hours for equilibration. The multiwell plates are then transported from the oxygen incubator 2 or 2′ to the sample input station 1. There, the membrane inserts of the multiwell plates are equipped by the operator with hippocampus sections which were prepared manually beforehand. The transport unit 8 then transports the equipped multiwell plates back to the oxygen incubator 2 or 2′.

To ensure that the samples can be unambiguously sorted at any time, the multiwell plates are preferably marked, for example with a barcode, which can then be read at any time both by the transport unit and by the various stations of the device according to the invention and can be compared with the existing data.

The hippocampus sections are cultivated in an oxygen incubator 2 or 2′ for a period of between six hours and 13 days or longer. During this residence time, cyclic media changes (e.g. change of the glucose medium), are carried out. For this purpose, the multiwell plates are transported to the media change station 4 and, after media change is complete, back into the incubator at intervals of 60 to 72 hours in each case. The cultures are cultivated until they are required by the operator for controls, usually after six to 13 days.

Preliminary checking of the samples takes place at the next step. For this purpose, a multiwell plate is transported from an oxygen incubator 2 or 2′ to the data acquisition station 5. There, transmission micrographs of the complete membrane inserts and of the individual sections of a membrane insert are prepared in a microscopy unit. The multiwell plate is then transported back into an oxygen incubator 2 or 2′.

The individual tissue sections are then evaluated on the basis of the transmission micrographs and specifics of the experiment are assigned to each of the individual membrane inserts of the multiwell plates and are communicated to the device according to the invention, for example via a computer terminal.

Depending on the assignment made, the membrane inserts of the multiwell plates are either removed if they were recognised as being unsuitable or are reassembled in multiwell plates, those inserts which are to be subjected to the same cultivation conditions being combined in one multiwell plate. This “pooling” can be effected, for example, in the media change station by the unit for removing and inserting membrane inserts from multiwell plates and the temporary storage of multiwell plates can be effected in the unit for the temporary storage of membrane inserts under controlled conditions. At the same time, the existing data of the device are appropriately updated so that the individual samples in the multiwell plates can be unambiguously assigned even after pooling of the membrane inserts.

For carrying out the experiments, for example, one of three possible conditions is assigned to each membrane insert by means of the specifics of the experiment:
Condition 1: OGD without addition of substance(s),
Condition 2: OGD with addition of substance(s),
Condition 3: Addition of substance(s) without OGD.

Here, “OGD” means that the cultures are being subjected to ischemic conditions, i.e. oxygen and glucose deprivation (OGD).

The individual conditions can be further specified, for example by stating the type and amount of the test substance to be used, duration of the OGD, etc.

About one hour before OGD, the multiwell plates with membrane inserts which are intended for condition 2 or condition 3 are transported by the transport unit 8 to the media change station 4. There, the glucose medium is exchanged for a glucose/test substance medium, and the multiwell plates are then transported back into an oxygen incubator 2 or 2′.

Before OGD, empty multiwell plates without membrane inserts in the wells are furthermore input into the device according to the invention either via the sample container storage station 6 or via the sample input station 1 and transported by the transport unit 8 to the media change station 4. The number of new multiwell plates which is introduced corresponds exactly to the number of multiwell plates which contain, for the imminent experiment, membrane inserts which are assigned condition 1 or condition 2. Moreover, a system-internal complementary assignment of the new multiwell plates takes place, in each case exactly one newly input multiwell plate being uniquely assigned to a multiwell plate which, for the imminent experiment, contains membrane inserts which are intended for condition 1 or condition 2.

In the media change station 4, bidistilled water is introduced between the wells of the newly input multiwell plates. In addition, a mannitol medium is introduced into those wells of the newly input multiwell plates in which membrane inserts which are intended for condition 1 are present on the complementary multiwell plates, and a mannitol/test substance medium is introduced into those wells of the newly input multiwell plates in which membrane inserts which are intended for condition 2 are present on the complementary multiwell plate. The newly input multiwell plates are then transported by the transport unit 8 into a nitrogen incubator unit 3, where they are equilibrated for between 20 minutes and 24 hours.

About one to five minutes before OGD, those multiwell plates which contain the membrane inserts with the tissue sections which are intended for condition 1 or condition 2, and the respective complementary multiwell plates with the mannitol medium, are transported by the transport unit 8 to the media change station 4. There, the membrane inserts which are intended for condition 1 or condition 2 are transferred from the multiwell plates with the glucose medium into the complementary multiwell plates with the mannitol medium. The multiwell plates with the mannitol medium are transported for OGD into the nitrogen incubator 3 and the multiwell plates with the glucose medium are transported into an oxygen incubator 2 or 2′.

For OGD, the multiwell plates with the mannitol medium remain, for example, for five to 90 minutes or longer in the nitrogen incubator 3 depending on the specifics of the experiment. Immediately after OGD, the multiwell plates with mannitol medium are transported from the nitrogen incubator 3 and the respective complementary plates with the glucose medium from an oxygen incubator 2 or 2′ to the media change station 4. There, the membrane inserts which are intended for condition 1 or condition 2 are transferred from the multiwell plates with the mannitol medium into the complementary wells of the complementary multiwell plates with the glucose medium, and the multiwell plates with the glucose medium are transported by the transport unit 8 into an oxygen incubator 2 or 2′. The empty multiwell plates with the mannitol medium are ejected via the sample output station 7 or 7′.

Multiwell plates with membrane inserts which are intended for condition 2 or condition 3 are transported about one hour after OGD by the transport unit 8 to the incubator station 4, and a medium change with glucose medium is carried out in those wells of the multiwell plate which contain membrane inserts for condition 2 or condition 3. The multiwell plates are then transported into an oxygen incubator 2 or 2′, in which incubation is effected for a period of between two and 72 hours.

If, according to the specifics of the experiment, the OGD is to be carried out several times for some multiwell plates, the steps of the experimental cycle which are described above are repeated accordingly.

For the evaluation of the experiment, the multiwell plate is transported about two hours before the data acquisition by the transport unit 8 from an oxygen incubator 2 or 2′ to the media change station 4, and propidium iodide (PI) is added in specified concentration to the wells of the multiwell plate. The multiwell plates are transported back into an oxygen incubator 2 or 2′ and remain there for about two hours. Immediately before the data acquisition, PI can once again optionally be added in the same or another concentration to the wells of the multiwell plate in the media change station 4.

Thereafter, the multiwell plates are transported to the data acquisition station and automatically transferred there to the microscopy unit. There, transmission and fluorescence micrographs of the complete membrane inserts and of the individual sections of a membrane insert are prepared under the microscope. Thereafter, the multiwell plates are taken over from the data acquisition station 5 by the transport unit 8 and, depending on the medium, ejected via a sample output station 7 or 7′.

The evaluation of the experiment on the basis of the transmission and fluorescence micrographs can be carried out manually by the operator.

The present invention is not limited to the above embodiment. For example, the device can be supplemented by additional stations or individual stations can be exchanged for others in order to adapt them to a corresponding experimental sequence. Within a respective station, it is also possible to adapt said station flexibly to a desired experimental sequence with little equipping or conversion effort.

The device according to the invention makes it possible to test a multiplicity of test substances in vitro with little manual effort, sequentially or in parallel, for the effect thereof on a tissue sample under normal conditions or under disease-simulating conditions. For example, the preclinical drug development or the preclinical development of a potential drug is substantially accelerated thereby, so that these can be carried out economically for a multiplicity of substances. Moreover, constant experimental conditions are ensured by the automated operations, so that the measured data obtained have high reproducibility and significance.

1. A device for automatically carrying out laboratory operations on cell or tissue samples, which comprises a plurality of modular stations, each of which carries out at least one operation in a total sequence of operations, and at least one transport unit for transporting sample containers to and between the stations, wherein the device has at least one station for automatically changing liquid media in the sample containers (media change station).

2. The device of claim 1, which comprises a sample input station, at least one incubator station, a media change station, a data acquisition station and a sample output station.

3. The device of claim 2, which comprises an oxygen incubator station and optionally a nitrogen incubator station.

4. The device of claim 1, which comprises a station for adding reagents to the sample containers.

5. The device of claim 1, which comprises sample containers in the form of plates having one or more wells which may contain membrane inserts, it being possible for each of the plates to have a cover plate.

6. The device of claim 1, wherein the media change station has optionally a unit for removing and mounting a cover plate of a sample container, optionally a unit for removing and inserting membrane inserts from wells of a plate of a sample container, a unit for removing a liquid medium from wells of a plate of a sample container, a unit for adding one or more liquid media to wells of a plate of a sample container and optionally a unit for mixing liquid media in wells of a plate of a sample container.

7. The device of claim 6, wherein the media change station furthermore has a unit for temporary storage of membrane inserts under controlled conditions.

8. The device of claim 6, wherein the media change station furthermore has a unit for removing liquid media from membrane inserts.

9. The device of claim 2, wherein the data acquisition station has a microscopy unit, a flow-through cytometer, a mass spectrometer, a spectroscope and/or devices for laser-based microdisection and/or electrophysiology.

10. The device of claim 1, which comprises: a sample input station in which cell tissue samples are manually introduced into membrane plates which are present in wells of a multiwell plate, the wells containing a culture medium for the cell tissue samples, an oxygen incubator station in which the cell tissue samples are cultivated, a media change station in which the culture medium in the multiwell plates is changed after predetermined time intervals, a reagent addition station in which one or more test substances whose action on the cell tissue samples is to be tested and/or optionally one or more substances which support the recording of measured data of the cell tissue samples are added to the wells of the multiwell plates, optionally an oxygen incubator station in which the cell tissue samples can, if required, additionally be incubated in the course of the experiment, a data acquisition station in which measured data of the cell tissue samples are acquired, for example, before and after addition of a test substance and/or cultivation in the nitrogen incubator, in order to determine the influence thereof on the cell tissue samples, a sample output station in which multiwell plates are ejected from the device after completion of the investigations, and a transport unit for transporting the multiwell plates from the sample input station to and between the stations up to the sample output station.

11. A method for carrying out investigations of chemical, biological and/or physical influences on physiological or pathophysiological processes on samples, preferably cell tissue samples using the device of claim 1.

12. The method of claim 11, wherein the device is used to test the effect of substances on samples, preferably on cell tissue samples.

13. The method of claim 11, wherein the device is used to identify and validate therapeutic targets.

14. A method for testing the effect of substances on samples, preferably on cell tissue samples, which comprises the steps of inputting input of samples into the device of claims 1 and evaluating measured data acquired in the data acquisition station.

15. The method of claim 14, comprising screening of active substances.
